(19) United States
(12) Patent Application Publication
(10) Pub. No.: US 2016/0271818 A1
(43) Pub. Date: Sep. 22, 2016

(54) SPEED SQUARE

(71) Applicant: Matthew Paul Papiese, Dwight, IL (US)

(72) Inventor: Matthew Paul Papiese, Dwight, IL (US)

(21) Appl. No.: 14/947,860

(22) Filed: Nov. 20, 2015

Related U.S. Application Data
(60) Provisional application No. 62/053,719, filed on Sep. 22, 2014.

(51) Int. Cl. B26B 29/06; B26D 7/20; E04D 15/02

(52) U.S. Cl. CPC B26B 29/06; E04D 15/02; B26D 7/20

(57) ABSTRACT

A roofing shingle speed square has a substantially rectangular board shaped body with side ridges aligned perpendicular to one another along adjacent first and second side edges of the board. A plurality of grooves defined in the surface of the board in spaced apart relation. The grooves providing a cutting guide for a blade to be drawn across and to cut the shingle.

### CROSS-REFERENCE TO RELATED APPLICATION

This application claims the benefit of priority of U.S. provisional application Ser. No. 62/053,719, filed Sep. 22, 2014, the contents of which are herein incorporated by reference.

### BACKGROUND OF THE INVENTION

The present invention relates to roofing shingles and, more particularly, to a cutting guide for roofing shingles.

When preparing shingles for application to a roof, it is often necessary to cut the shingles to a desired length. Depending on the dimensions of the roof, preparing a row of evenly cut shingles is important so as to ensure the shingles properly seal and protect the roof, and also to provide a proper liner alignment for subsequent rows of shingles.

Current shingle guides are heavy, require preparation and set-up to obtain a desired shingle length, and present safety concerns to the user.

As can be seen, there is a need for an improved shingle cutting guide that is light weight, cost effective, and provides enhanced safety and accuracy.

### SUMMARY OF THE INVENTION

In one aspect of the present invention, a cutting apparatus comprises: an elongate board defining a support surface; a first side ridge defined along an first edge of the elongate board and extending above the support surface; a second side ridge oriented defined along a second edge of the elongate board and extending above the support surface, wherein the first side ride is oriented substantially perpendicular to the second side ridge; and a plurality of grooves defined in spaced apart relation across the support surface, the grooves aligned substantially parallel to the first side ridge and substantially perpendicular to the second side ridge.

The cutting apparatus may further comprise a ruled surface defined along a length of the second side ridge. The plurality of grooves may have an insert received within the plurality of grooves. In some embodiments, the grooves may be substantially U shaped along their transverse dimension. In other embodiments, the grooves are substantially V shaped along their transverse dimension. The grooves may be defined to correspond to a primary marking on the ruled surface.

Another aspect of the invention includes a method of cutting a roofing shingle comprising: 1) providing a cutting apparatus comprising, an elongate board defining a shingle support surface; a first side ridge defined along an first edge of the elongate board and extending above the support surface; a second side ridge oriented defined along a second edge of the elongate board and extending above the support surface, wherein the first side ride is oriented substantially perpendicular to the second side ridge; and a plurality of grooves defined in spaced apart relation across the support surface, the grooves aligned substantially parallel to the first side ridge and substantially perpendicular to the second side ridge; 2) placing a shingle on the support surface; 3) positioning an edge of the shingle in abutment with the first side ridge and the second side ridge. The method may also include, inserting a cutting blade into a selected groove proximal to the shingle. The method drawing the cutting blade along the selected groove to cut the shingle. In other aspects of the invention, the method may further comprise providing an insert to be received within the groove.

These and other features, aspects and advantages of the present invention will become better understood with reference to the following drawings, description and claims.

### BRIEF DESCRIPTION OF THE DRAWINGS

FIG. 1: Is a perspective view of the shingle cutting guide of the invention shown in use.

FIG. 2: Is a top view of the shingle cutting guide.

FIG. 3: Is a perspective view of the shingle cutting guide.

FIG. 4: Is a detail exploded view of the shingle cutting guide.

FIG. 5: Is a section detail view of the shingle cutting guide shown along line 5-5 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an apparatus and method for a cutting guide, or roofer's speed square, for cutting roofing shingles to a uniform desired length.

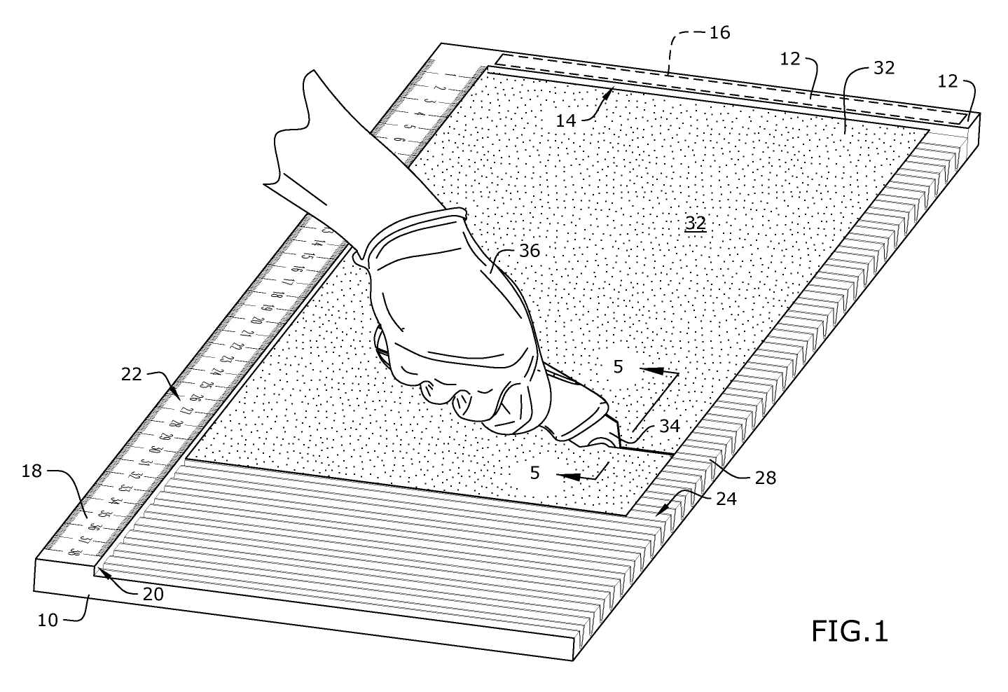

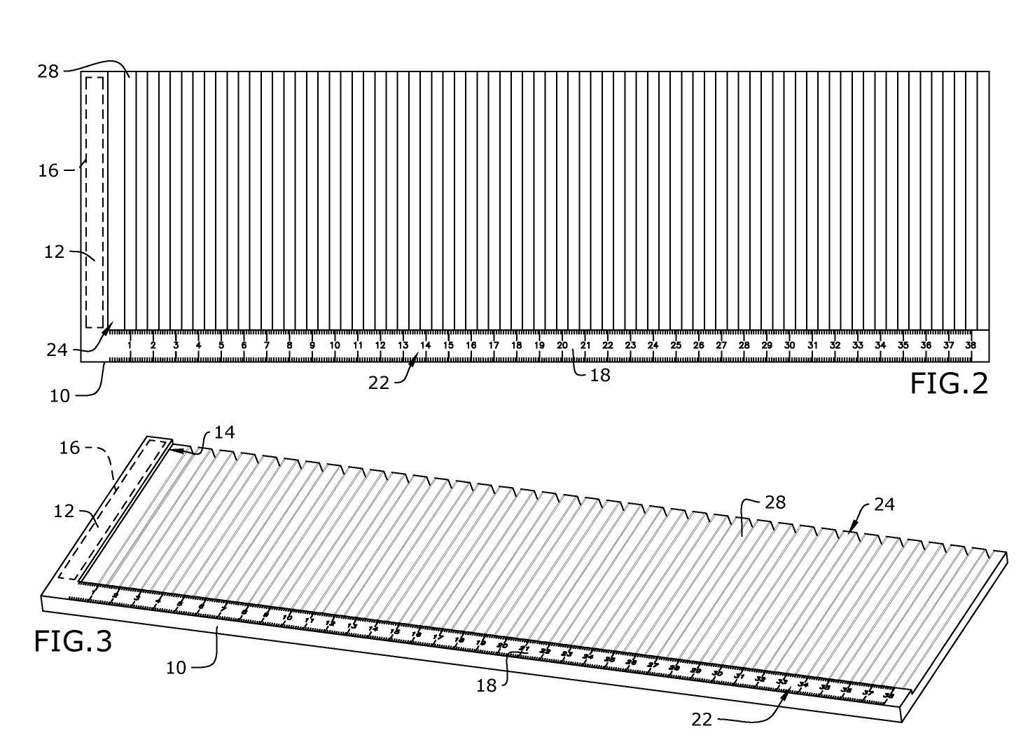

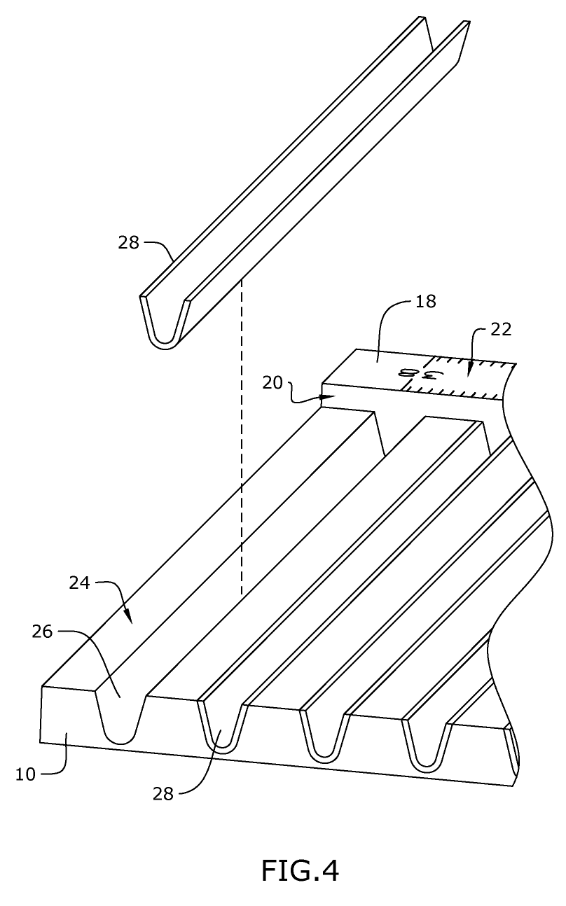

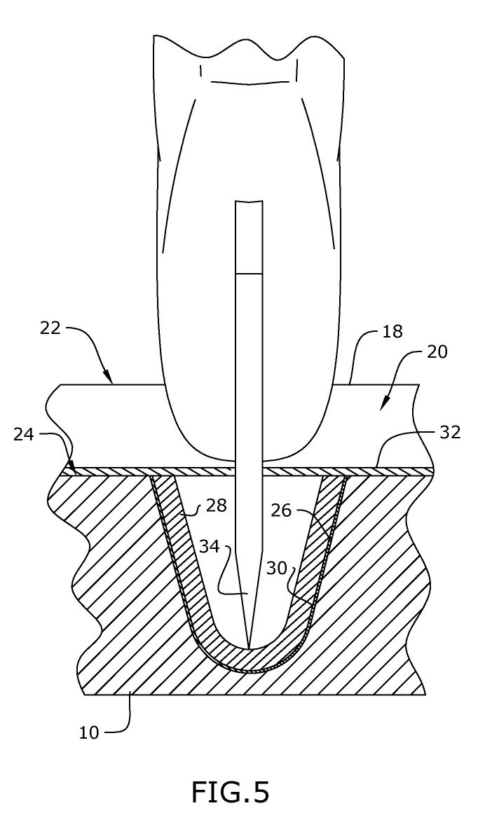

As best seen in reference to FIGS. 1-4, the guide includes a substantially rectangular board shaped body 10. The board 10 may be formed of any suitable light weight material, such as wood, metal, or high durability plastic. The body 10, may include a side ridge 12 that is preferably aligned at a right angle to a lower ridge 18. The side ridge 12 may include an inwardly oriented side ridge butt surface 14. In similar manner, the lower ridge 18/may include an inwardly oriented lower ridge butt surface 20. A ruled surface 22 may be provided along the length of the lower ridge 18. The ruled surface 22 may also be provided with one or more standard dimension identifiers, to provide the user a quick reference for ease of alignment and cutting a shingle to a desired length.

A shingle support surface 24 is provided by a majority portion of the body of the board 10. The shingle support surface 24 has a plurality of grooves 26 defined therein, wherein the grooves 26 extend substantially perpendicular to the lower ridge 18 and substantially parallel to the side ridge 12. Preferably, the grooves are defined in spaced apart relation to correspond with primary markings on the ruled surface 22. The channels will have a depth so as to receive a portion of the cutting blade 34 therein, when operated by the user to cut a shingle 32 placed on the support surface 24.

The channel may be defined in a modified U shape or V shape to receive the cutting blade 34. In a preferred embodiment, the grooves 26 may be provided with an insert 28 that protects the groove 26 of the support surface 24. The insert 28 may be secured as a press fit within the groove 26 or a may be secured via an adhesive layer 30 applied between the insert 28 and the groove 26. The insert may be formed of nylon, metal

As best seen in reference to FIGS. 1 & 5, to use the present invention, a user 36 would place a shingle 32 on the support surface 24 and position the edges of the shingle 32 in abutment with the side ridge but surface 14 and the lower ridge butt surface 20 so as to square up the shingle 32 with the device.

The user would select a desired length for cutting the shingle 32 by reference to the ruled surface 22 and selecting a corresponding groove 26 for the desired length. The user 36 may then place the cutting blade 34 of into the corresponding groove 26 proximal to an edge of the shingle 32. The user 36 would then draw the cutting blade 34 across the shingle 32 to cut the shingle to the desired length. The cut shingle 32 would then be available to be installed at the particular portion off the roof for which it is cut. As will be appreciated, the user may cut a number of

It should be understood, of course, that the foregoing relates to exemplary embodiments of the invention and that modifications may be made without departing from the spirit and scope of the invention as set forth in the following claims.

What is claimed is:

1. A cutting apparatus comprising,
an elongate board defining a support surface;
a first side ridge defined along an first edge of the elongate board and extending above the support surface;
a second side ridge oriented defined along a second edge of the elongate board and extending above the support surface, wherein the first side ride is oriented substantially perpendicular to the second side ridge; and
a plurality of grooves defined in spaced apart relation across the support surface, the grooves aligned substantially parallel to the first side ridge and substantially perpendicular to the second side ridge.

2. The cutting apparatus of claim 1, further comprising:
a ruled surface defined along a length of the second side ridge

3. The cutting apparatus of claim 1, further comprising:
an insert received within the plurality of grooves.

4. The cutting apparatus of claim 1, wherein the grooves are substantially U shaped along their transverse dimension.

5. The cutting apparatus of claim 1, wherein the grooves are substantially V shaped along their transverse dimension.

6. The cutting apparatus of claim 1, wherein the grooves are defined to correspond to a primary marking on the ruled surface.

7. A method of cutting a roofing shingle comprising:
providing a cutting apparatus comprising,
an elongate board defining a shingle support surface;
a first side ridge defined along an first edge of the elongate board and extending above the support surface;
a second side ridge oriented defined along a second edge of the elongate board and extending above the support surface, wherein the first side ride is oriented substantially perpendicular to the second side ridge; and
a plurality of grooves defined in spaced apart relation across the support surface, the grooves aligned substantially parallel to the first side ridge and substantially perpendicular to the second side ridge;
placing a shingle on the support surface;
positioning an edge of the shingle in abutment with the first side ridge and the second side ridge.

8. The method of claim 7, further comprising:
inserting a cutting blade into a selected groove proximal to the shingle.

9. The method of claim 8, further comprising:
drawing the cutting blade along the selected groove to cut the shingle.

10. The method of claim 7, further comprising;
providing an insert to be received within the groove.
